(19) United States
(12) Patent Application Publication
(10) Pub. No.: US 2020/0286107 A1
(43) Pub. Date: Sep. 10, 2020

(54) FACILITATING POSITIVE RESPONSES FOR ELECTRONIC COMMUNICATIONS FROM TEMPORAL GROUPS

(71) Applicant: International Business Machines Corporation, Armonk, NY (US)

(72) Inventors: Al Chakra, Apex, NC (US); Liam S. Harpur, Dublin (IE); Brian O'Donovan, Dublin (IE); John Rice, Tramore (IE)

(21) Appl. No.: 16/295,118

(22) Filed: Mar. 7, 2019

(51) Int. Cl. G06Q 30/02; G06F 16/28; G06Q 50/00; G06N 20/00; H04L 12/58

(52) U.S. Cl. CPC G06Q 30/0202; G06F 16/285; H04L 51/32; G06Q 50/01; G06N 20/00; G06Q 30/0204

(57) ABSTRACT

Incubating electronic communications with favorable responses prior to the electronic communications becoming publicly available. An electronic communication is generated by an author and a target objective for the electronic communication is provided. Characteristics of the generated electronic communication are determined and a plurality of users of the communication system is predicted to temporally define one or more audience groups likely to react favorably to content of the electronic communication based on the one or more characteristics of the electronic communication corresponding with information from prior communications of the plurality of users of the communication system. Responses are received from at least some of the users of the audience group in response to the author's electronic communication. Upon achieving a target objective, the electronic communication is transmitted or posted for other users of the communication system.

### BACKGROUND

The invention relates generally to submitting electronic communications for review and, more particularly, to generating one or more groups likely to receive an electronic communication in a favorable way prior to subsequently making the electronic communication available to others.

It is important to know your audience when presenting your work for review. For example, when posting an electronic communication someone can quickly undermine the positive aspects of the post before the majority of others get an opportunity to comment. The comments posted in response sometimes unfairly influence others from reviewing the post upon its own merits. Sometimes others will review the comments before even reading the content of the post and, if the credibility of the post is affected before the merits can be realized, the post will likely then never be read. Thus, what is needed is the ability for authors to incubate electronic communications with favorable responses before the electronic communications are available to members of the public.

### SUMMARY

According to a non-limiting embodiment, a computer implemented method for an author to incubate electronic communications with favorable responses prior to the electronic communications becoming publicly available via a communication system is provided. The method includes generating an electronic communication by an author and the author providing a target objective for the electronic communication. The method then includes determining one or more characteristics of the generated electronic communication and predicting a plurality of users of the communication system likely to react favorably to content of the electronic communication based on the one or more characteristics of the electronic communication corresponding with information from prior communications of the plurality of users of the communication system. The method also includes temporally defining one or more audience groups from the plurality of users predicted to react favorably to content of the electronic communication from the author and receiving responses from at least a portion of the plurality of users of the one or more audience groups in response to the author's electronic communication. The method then includes determining whether the target objective is achieved based on the responses received from the at least a portion of the plurality of users of the one or more audience groups and, upon achieving the target objective for the electronic communication, transmitting or posting the electronic communication for other users of the communication system in addition to the users of the one or more audience groups.

According to another non-limiting embodiment, a system for incubating electronic communications with favorable responses prior to the electronic communications becoming publicly available is provided. The system includes an electronic communication generated by an author and a target objective which much be achieved to change the public availability of the electronic message. The system also includes a temporal audience group of a plurality of users predicted to react favorably to content of the electronic communication from the author and a plurality of responses received from at least a portion of the plurality of users of the temporal audience group in response to the author's electronic communication. The system then includes a determination whether the target objective is achieved based on the responses received from the at least a portion of the plurality of users of the temporal audience group.

According to yet another non-limiting embodiment, a computer program product for an author to incubate electronic communications with favorable responses prior to the electronic communications becoming publicly available via a communication system is provided. The computer program product includes a computer readable storage medium having program instructions embodied therewith, the program instructions executable by a computer processor to cause the computer processor to perform a method. A non-limiting example of the method includes generating an electronic communication by an author and the author providing a target objective for the electronic communication and determining one or more characteristics of the generated electronic communication. The method also includes predicting a plurality of users of the communication system likely to react favorably to content of the electronic communication based on the one or more characteristics of the electronic communication corresponding with information from prior communications of the plurality of users of the communication system and temporally defining one or more audience groups from the plurality of users predicted to react favorably to content of the electronic communication from the author. The method then includes receiving responses from at least a portion of the plurality of users of the one or more audience groups in response to the author's electronic communication and determining whether the target objective is achieved based on the responses received from the at least a portion of the plurality of users of the one or more audience groups. The method also includes upon achieving the target objective for the electronic communication, transmitting or posting the electronic communication for other users of the communication system in addition to the users of the one or more audience groups.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which:

FIG. 1 is a block diagram illustrating a computer system capable of generating electronic communications and communicating with a server such as a web server to facilitate the electronic communications via the World Wide Web in accordance with various embodiments of the invention;

FIG. 2 is a block diagram illustrating a user interface of an email client for drafting an electronic communication/message according to one or more embodiments of the present invention;

FIG. 3 is a block diagram illustrating a computer system generating electronic communications for selected users of a communication system and receiving responses from the selected users according to one or more embodiments of the present invention; and

FIG. 4 is a flow diagram illustrating a method for incubating electronic communications with favorable responses prior to the electronic communications becoming publicly available according to one or more embodiments of the present invention.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

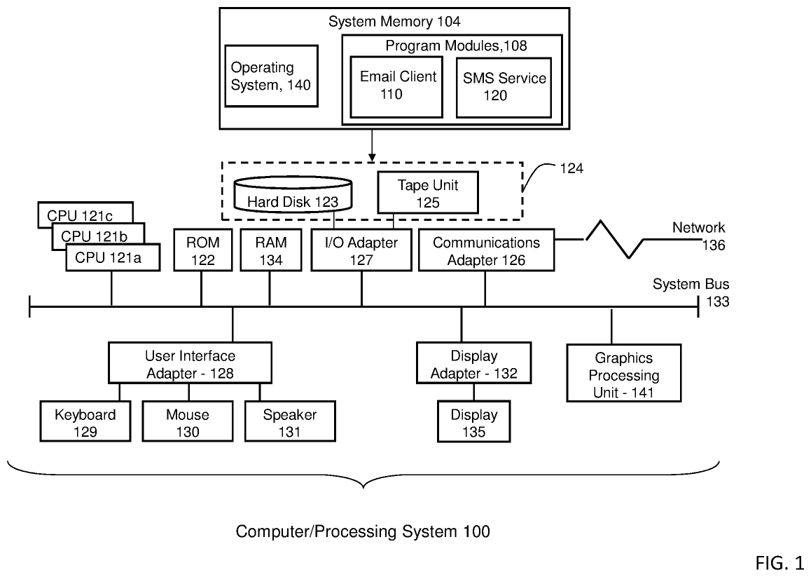

Referring now to FIG. 1, a computer system 100 is illustrated according to a non-limiting embodiment. In FIG. 1 the computer system 100 is shown in the form of a general-purpose computing device, which also may be referred to as a processing device, but may otherwise be, for example, a mobile telephone, a smartphone, a tablet personal computer, a laptop computer, and the like, for implementing the teachings herein.

The components of computer system 100 may include, but are not limited to, one or more central processing units (processors) 121a, 121b, 121c, etc. (collectively or generically referred to as processor(s) 121). In one or more embodiments, each processor 121 may include a reduced instruction set computer (RISC) microprocessor. Processors 121 are coupled to system memory (RAM) 134 and various other components via a system bus 133. Read only memory (ROM) 122 is coupled to the system bus 133 and may include a basic input/output system (BIOS), which controls certain basic functions of computer system 100.

FIG. 1 further depicts an input/output (I/O) adapter 127 and a network adapter 126 coupled to the system bus 133. I/O adapter 127 may be a small computer system interface (SCSI) adapter that communicates with a hard disk 123 and/or tape storage drive 125 or any other similar component. I/O adapter 127, hard disk 123, and tape storage device 125 are collectively referred to herein as mass storage 124.

Still referring to FIG. 1, depending on the configuration and type of computer system 100, system memory 104 comprises, but is not limited to, volatile storage (e.g., random access memory), non-volatile storage (e.g., read-only memory), flash memory, or any combination of such memories. According to an aspect, the system memory 104 includes an operating system 140 and one or more program modules 108 suitable for running software applications. The operating system 140, for example, is suitable for controlling the operation of the computer system 100. Operating system 140 may be stored in mass storage 124. However, the operating system 140 may also be stored in RAM 134 of the computer system 100. Operating systems according to embodiments of the present invention include, for example, UNIX™, Linux™, Microsoft XP™, AIX™, and IBM's i5/OS™.

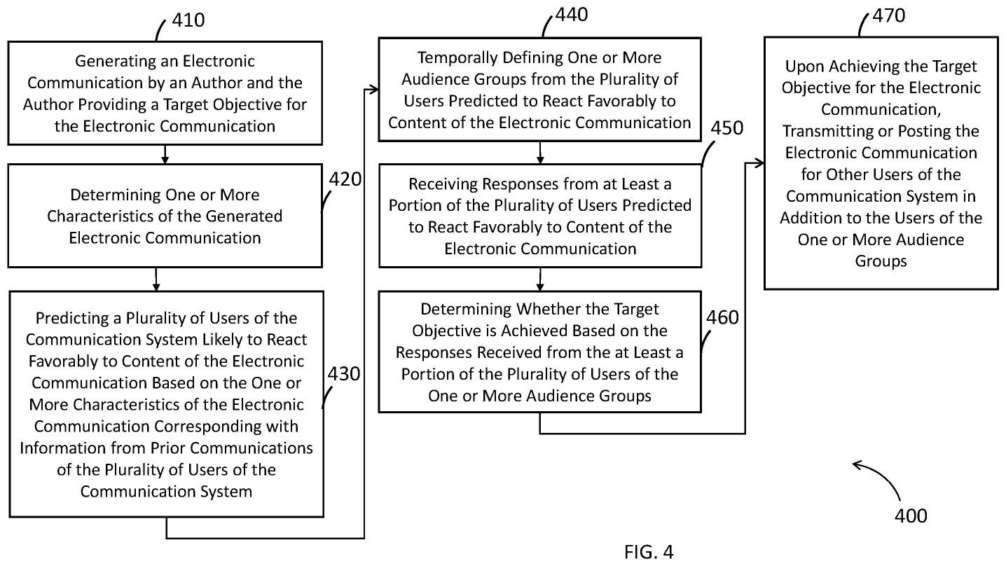

According to an aspect, the program modules 108 include an email client 110 for message management, composition, transmission and reception of electronic communications for individuals and organizations. The email client 110 may sometimes be referred to as a mail user agent (MUA). An SMS (Short Message Service) application 120 for texting messages or any other type of service such as an internet or web hosting service provider for a blog or peer review website or tool may be included that is capable of message management, composition, transmission and reception of electronic communications for individuals and organizations. Preferably FTP (File Transfer Protocol) access via an FTP client or other client for uploading and transferring files is included. While executing, the program modules 108 (e.g., email client 110, SMS application 120) perform processes including, but not limited to, one or more of the stages of the method 400 illustrated in FIG. 4.

A network adapter 126 interconnects bus 133 with an outside network 136 enabling the computer system 100 to communicate with other such systems. A screen (e.g., a display monitor) 135 is connected to system bus 133 by display adaptor 132, which may include a graphics adapter to improve the performance of graphics intensive applications and a video controller. In one embodiment, adapters 127, 126, and 132 may be connected to one or more I/O busses that are connected to system bus 133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 133 via user interface adapter 128 and display adapter 132. A keyboard 129, mouse 130, and speaker 131 all interconnected to bus 133 via user interface adapter 128, which may include, for example, a Super I/O chip integrating multiple device adapters into a single integrated circuit.

In exemplary embodiments, the computer system 100 includes a graphics processing unit 141. Graphics processing unit 141 is a specialized electronic circuit designed to manipulate and alter memory to accelerate the creation of images in a frame buffer intended for output to a display. In general, graphics processing unit 141 is very efficient at manipulating computer graphics and image processing and has a highly parallel structure that makes it more effective than general-purpose CPUs for algorithms where processing of large blocks of data is done in parallel.

Thus, as configured in FIG. 1, the computer system 100 includes processing capability in the form of the processors 121, storage capability including RAM 134 and mass storage 124, input means such as keyboard 129 and mouse 130, and output capability including speaker 131 and display 135. In one embodiment, a portion of RAM 134 and mass storage 124 collectively store the operating system 140 to coordinate the functions of the various components shown in FIG. 1.

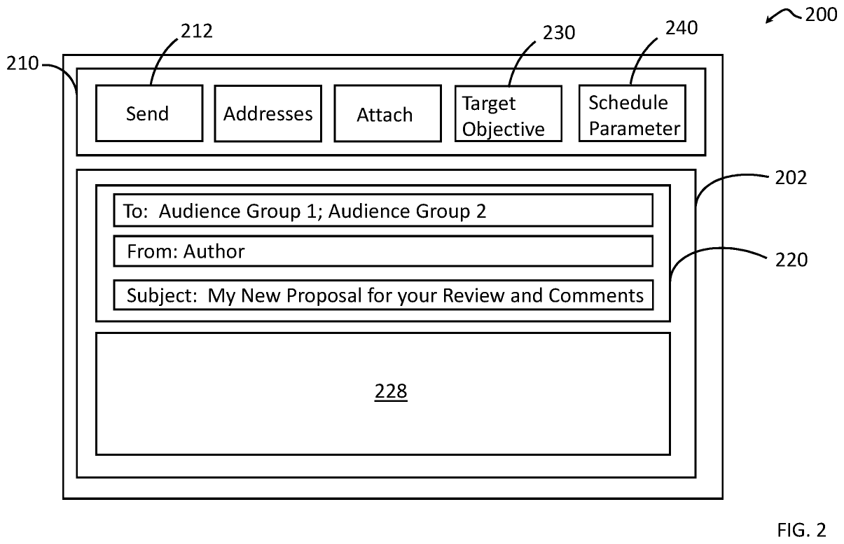

FIG. 2 depicts a user interface 200 of an email client 110 for the user/author where an electronic communication such as a message 202 is being drafted. In one or more embodiments, the user interface 200 has a toolbar 210 with one or more buttons such as send button 212. Also, the message 202 includes a message header 220 and a message body 228. The message 202 may also include one or more attachments. The toolbar 210 can also include a target objective 230 and a schedule parameter 240. After the author drafts the body 228 of the message 202 or includes an attachment, the author can then select or enter the target objective 230 and the schedule parameter 240, the purposes of which are described in greater detail below.

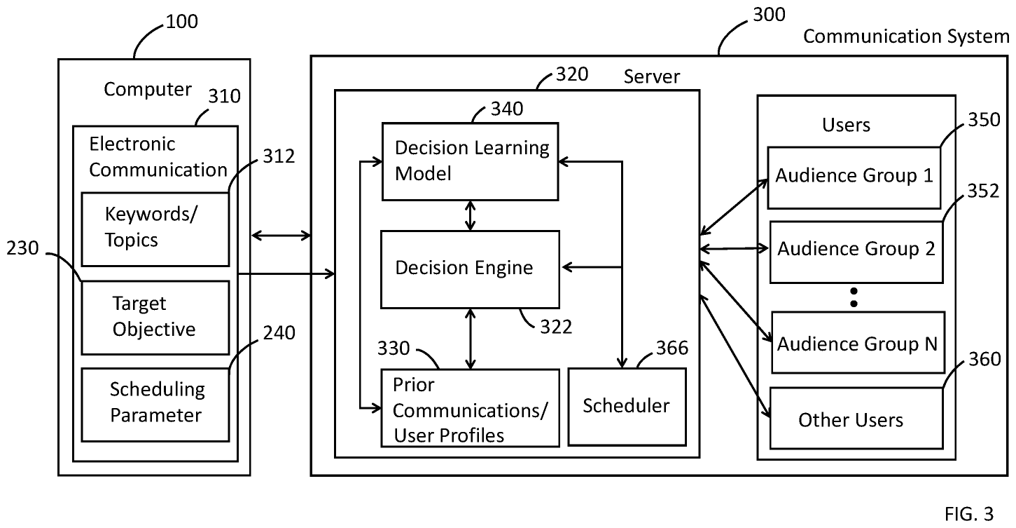

FIG. 3 illustrates an exemplary embodiment for passing electronic communications to one or more selected groups predicted from users of a communication system 300 and then receiving responses from those groups of users. In particular, in FIG. 3 the computer system 100 is depicted along with an electronic communication 310 generated by an author and received at a server 320 of the communication system 300. In one or more embodiments, the electronic message 310 includes the target objective 230 and the scheduling parameter 240. One or more characteristics of the electronic communication 310 can be determined from keywords or topics 312 determined from the electronic communication 310. For example, if the electronic communication 310 is an electronic message such as the email message 202 then keywords and topics can be determined by the server 320 from the message header 220, the message body 228, and/or the attachment.

If the author desires to generate one or more groups of users likely to receive the electronic communication in a good or positive way prior to subsequently making the electronic communication available to others, the author can select one or more audience groups 350, 352 determined by the server 320. The server 320 includes a decision engine 322 and a database of or access to prior communications/user profiles 330 of the users of the communication system 300. Profiles for the users can be generated based on information from their prior communications such as, for example, keywords, topics, the identities of the users and who they typically correspond with, and the frequency of correspondence with one or more other users and/or with the author himself.

Furthermore, a decision learning model 340 predicts which users of the communication system 300 are likely to react favorably to content of the electronic communication 310 drafted by the author based on the one or more characteristics of the author's electronic communication 310 such as the keywords/topics 312 which correspond with information from the prior communications/user profiles 330 of the users of the communication system 300. The decision engine 322 then temporally defines the one or more audience groups, 350, 352 of users that were predicted to react favorably to the content of the electronic communication from the author. In one or more embodiments, the author can designate the number of audience groups 1 to N for the decision engine 322 to temporally define.

The decision learning model 340 is trained using pre-existing or known data/inputs and outcomes or results from the decision engine 322 wherein the outcomes or results are previous or historical decisions as to what groups of users likely will provide favorable responses. Using analytic capabilities and techniques, the decision learning model 340 establishes relationships between the inputs and the results. Once deemed accurate based on the historical data and corresponding outcomes, the decision learning model 340 is then applied to new inputs to predict automated outcomes/results.

As referenced above in regard to FIG. 2, the author of the electronic communication 310 can indicate a target objective 230 to be achieved based on the responses received from at least a portion of the users of the one or more audience groups 350, 352 in response to the author's electronic communication 310. In one or more embodiments, the target objective 230 is a predetermined percentage of favorable responses received from the users of the one or more audience groups 350, 352. For example, the author could indicate a 70% favorable rate is required from the responses of the one or more audience groups 350, 352. In one or more other examples, different percentages of received favorable responses could be required.

In FIG. 3, for example, the electronic communication 310 is sent to the audience groups 350, 352 by selecting the send button 212 in the toolbar 210 of the user interface 200 of FIG. 2. In one or more other embodiments, the responses from the audience groups 350, 352 could then be characterized as different levels of responses and corresponding percentages could be assigned for the needed amounts of the different levels of favorable responses. For example, responses from the audience groups 350, 352 could be characterized as a first level where the response is a “like” received via social media, a second level where the response is a “like” and a positive comment, and a third level where the responses is a “like,” a positive comment, and includes forwarding the electronic communication from the author to someone else.

One or more embodiments may also have a scheduling parameter 240 for a scheduler 366, for achieving the target objective 230, included in the electronic communication 310 of the author. For example, the scheduling parameter 240 may be a predetermined length of time, such as, for example, a few hours, a few days, or a few weeks, to receive favorable responses from the audience groups 350, 350 for achieving the target objective 230. In one or more embodiments, if the target objective 230 is not achieved based on the scheduling parameter 240, a time period may be extended by the user or automatically by the decision engine 322 via the scheduler 366 in order to receive additional responses from the users of the one or more audience groups 350, 352 and, thereby, continue to try to achieve the target objective 230. Also, in one or more embodiments, the author or the decision engine 322 could increase or expand the number of users within at least one or more of the audience groups 350, 352 to include additional users if the target objective 230 has not yet been achieved within a predetermined time period. In such case, there would be an increased risk that unfavorable responses would be received from the users added to the one or more audience groups 350, 352.

The decision engine 322 determines whether the target objective 230 has been achieved within the scheduling parameter 240 via the scheduler 366 based on the responses received from at least a portion of the plurality of users of the one or more audience groups 350, 352. Upon achieving the target objective 230 for the electronic communication 310, as long as the scheduling parameter 240 via the scheduler 366 has also been satisfied, the server 320 then transmits, posts or otherwise conveys the electronic communication 310 to other users 360 of the communication system 300 in addition to the users of the one or more audience groups 350, 352 that have already received the electronic communication 310. In such case, the author may be prompted to send the electronic communication 310 to the other users 360 or the server 320 could automatically send the electronic communication to the other users 360 if the author had previously selected the other users 360. In one or more embodiments, the server 320 based on the scheduler 366 can delay the electronic communication 310 from being received by the other users 360 if the scheduling parameter 240 such as a time period has not yet expired.

Still referring to FIG. 3, output from the decision engine 322, the scheduler 366, and information from the prior communications/user profiles 330, whether or not the target objective 230 was achieved pursuant to the scheduling parameter 240, can then be utilized as input for the decision learning model 340 according to one or more embodiments of the present invention. The decision learning model 340 is applied to the inputs in order to then predict future performance of the decision engine 322. Thus, the results from the decision learning model 340 are provided to the decision engine 340. Based on the results from the decision learning model 340, the decision engine 340 automatically determines the one or more audience groups 1 to N for drafted electronic communications.

Turning now to FIG. 4, a computer implemented method 400 for an author to incubate electronic communications with favorable responses prior to the electronic communications becoming publicly available via a communication system is illustrated according to a non-limiting embodiment. The flow diagram of FIG. 4 illustrates the method 400 that includes process block 410 for generating an electronic communication by an author and the author providing a target objective for the electronic communication and process block 420 for determining one or more characteristics of the generated electronic communication. The method 400 also includes process block 430 for predicting a plurality of users of the communication system likely to react favorably to content of the electronic communication based on the one or more characteristics of the electronic communication corresponding with information from prior communications of the plurality of users of the communication system. The method 400 then includes process 440 for temporally defining one or more audience groups from the plurality of users predicted to react favorably to content of the electronic communication from the author. The method 400 also includes process block 450 for receiving responses from at least a portion of the plurality of users of the one or more audience groups in response to the author's electronic communication and process block 460 for determining whether the target objective is achieved based on the responses received from the at least a portion of the plurality of users of the one or more audience groups. The method 400 then also includes process block 470 for, upon achieving the target objective for the electronic communication, transmitting or posting the electronic communication for other users of the communication system in addition to the users of the one or more audience groups.

The computer-implemented method 400 may also include one or more other process blocks. In one or more embodiments, the method 400 can include receiving responses from one or more audience groups that include at least one of the following levels of responses: a first level including a like received via social media, a second level including the like and a positive comment, and a third level including the like, the positive comment, and forwarding the electronic communication from the author to someone else. The method 400 can also include the electronic communication being an electronic mail transmitted to the one or more audience groups or a post shared via a blog or a social media website. The method 400 can include the author providing a scheduling parameter for achieving the target objective wherein the target objective is a predetermined percentage of favorable responses received from the users of the one or more audience groups. The method 400 can also include the author providing a scheduling parameter for achieving the target objective and, when the target objective is not achieved based on the scheduling parameter, extending a time period to receiving additional responses from the users of the one or more audience groups in order to continue trying to achieve the target objective.

In one or more embodiments, the method 400 can include expanding the number of users within at least one of the one or more audience groups if the target objective is not yet achieved with a predetermined time period. The method 400 can also include receiving user-provided inputs associated with the electronic communication, wherein the user provided-provided inputs comprise at least one of: a number of audience groups to temporally define, and a scheduling parameter indicating a predetermined length of time for achieving the target objective. The method 400 can include applying a decision learning model to the characteristics of the generated electronic communication of the author and to the prior communications of the users of the communication system for determining via the decision learning model which of the plurality of users are likely to provide favorable responses in response to the electronic communication. The method 400 can also include training the decision learning model with the information from the prior communications of the users of the communication system and with historically defined audience groups and corresponding target objectives.

Various technical benefits are achieved using the system and methods described herein, including the capability of providing enhanced performance for applications with exclusive access to the co-processors while also allowing applications that do not need performance access to accelerators when shared access is available. In this manner, the computer system can realize performance gains through the use of co-processors in the system, thereby improving overall processing speeds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for an author to incubate electronic communications with favorable responses prior to the electronic communications becoming publicly available via a communication system, comprising:
generating an electronic communication by an author and the author providing a target objective for the electronic communication;
determining one or more characteristics of the generated electronic communication;
predicting a plurality of users of the communication system likely to react favorably to content of the electronic communication based on the one or more characteristics of the electronic communication corresponding with information from prior communications of the plurality of users of the communication system;
temporally defining one or more audience groups from the plurality of users predicted to react favorably to content of the electronic communication from the author;
receiving responses from at least a portion of the plurality of users of the one or more audience groups in response to the author's electronic communication;
determining whether the target objective is achieved based on the responses received from the at least a portion of the plurality of users of the one or more audience groups; and
upon achieving the target objective for the electronic communication, transmitting or posting the electronic communication for other users of the communication system in addition to the users of the one or more audience groups.

2. The computer implemented method of claim 1 wherein the responses received from the one or more audience groups includes at least one of the following levels of responses:
a first level including a like received via social media;
a second level including the like and a positive comment; and
a third level including the like, the positive comment, and forwarding the electronic communication from the author to someone else.

3. The computer implemented method of claim 1 wherein the electronic communication is electronic mail transmitted to the one or more audience groups.

4. The computer implemented method of claim 1 wherein the electronic communication is a post shared via a blog or a social media website.

5. The computer implemented method of claim 1 wherein the author further provides a scheduling parameter for achieving the target objective.

6. The computer implemented method of claim 1 wherein the target objective is a predetermined percentage of favorable responses received from the users of the one or more audience groups.

7. The computer implemented method of claim 1 wherein the author further provides a scheduling parameter for achieving the target objective and, when the target objective is not achieved based on the scheduling parameter, extending a time period to receiving additional responses from the users of the one or more audience groups in order to continue trying to achieve the target objective.

8. The computer implemented method of claim 1 further comprising expanding a number of users within at least one of the one or more audience groups if the target objective is not yet achieved with a predetermined time period.

9. The computer implemented method of claim 1 further comprising receiving user-provided inputs associated with the electronic communication, wherein the user-provided inputs comprise at least one of:
a number of audience groups to temporally define; and
a scheduling parameter indicating a predetermined length of time for achieving the target objective.

10. The computer implemented method of claim 1 further comprising applying a decision learning model to the characteristics of the generated electronic communication of the author and to the prior communications of the users of the communication system for determining via the decision learning model which of the plurality of users are likely to provide favorable responses in response to the electronic communication.

11. The computer implemented method of claim 10 further comprising training the decision learning model with the information from the prior communications of the users of the communication system and with historically defined audience groups and corresponding target objectives.

12. A system for incubating electronic communications with favorable responses prior to the electronic communications becoming publicly available, the system comprising:
an electronic communication generated by an author and a target objective which much be achieved to change the public availability of the electronic communication;
a temporal audience group of a plurality of users predicted to react favorably to content of the electronic communication from the author;
a plurality of responses received from at least a portion of the plurality of users of the temporal audience group in response to the author's electronic communication; and
a determination whether the target objective is achieved based on the responses received from the at least a portion of the plurality of users of the temporal audience group.

13. The system of claim 12 further comprising a scheduler receiving a scheduling parameter for achieving the target objective, wherein the target objective is a predetermined percentage of favorable responses received from the users of the audience group.

14. The system of claim 12 wherein the electronic communication is electronic mail transmitted to the audience group or a post shared via a blog or a social media website.

15. The system of claim 12 further comprising a decision learning model applied to characteristics of the electronic communication of the author and to prior communications of the users of a communication system for determining via the decision learning model which of the users are likely to provide favorable responses in response to the electronic communication.

16. A computer program product comprising a computer readable storage medium having program instructions embodied therewith, the program instructions executable by a computer processor to cause the computer processor to perform a method for an author to incubate electronic communications with favorable responses prior to the electronic communications becoming publicly available via a communication system, comprising:
generating an electronic communication by an author and the author providing a target objective for the electronic communication;
determining one or more characteristics of the generated electronic communication;
predicting a plurality of users of the communication system likely to react favorably to content of the electronic communication based on the one or more characteristics of the electronic communication corresponding with information from prior communications of the plurality of users of the communication system;
temporally defining one or more audience groups from the plurality of users predicted to react favorably to content of the electronic communication from the author;
receiving responses from at least a portion of the plurality of users of the one or more audience groups in response to the author's electronic communication;
determining whether the target objective is achieved based on the responses received from the at least a portion of the plurality of users of the one or more audience groups; and
upon achieving the target objective for the electronic communication, transmitting or posting the electronic communication for other users of the communication system in addition to the users of the one or more audience groups.

17. The computer program product of claim 16 further comprising the author providing a scheduling parameter for achieving the target objective and, when the target objective is not achieved based on the scheduling parameter, extending a time period to receiving additional responses from the users of the one or more audience groups in order to continue trying to achieve the target objective.

18. The computer program product of claim 16 further comprising expanding a number of users within at least one of the one or more audience groups if the target objective is not yet achieved with a predetermined time period.

19. The computer program product of claim 16 further comprising applying a decision learning model to the characteristics of the generated electronic communication of the author and to the prior communications of the other users of the communication system for determining via the decision learning model which of the plurality of users are likely to provide favorable responses to the electronic communication.

20. The computer program product of claim 19 further comprising training the decision learning model with the information from the prior communications of the users of the communication system and with historically defined audience groups and corresponding target objectives.
